(19) United States
(12) Patent Application Publication
(10) Pub. No.: US 2013/0316204 A1
(43) Pub. Date: Nov. 28, 2013

(54) ELECTRODE ASSEMBLY, FABRICATING METHOD THEREOF, AND RECHARGEABLE BATTERY

(71) Applicant: SAMSUNG SDI CO., LTD., Yongin-si (KR)

(72) Inventor: Chan-Seok KIM, Yongin-si (KR)

(73) Assignee: SAMSUNG SDI CO., LTD., Yongin-si (KR)

(21) Appl. No.: 13/742,238

(22) Filed: Jan. 15, 2013

(30) Foreign Application Priority Data
May 22, 2012 (KR) 10-2012-0054359

(51) Int. Cl. H01M 10/04

(52) U.S. Cl. CPC H01M 10/0431
USPC 429/94; 29/623.1

(57) ABSTRACT

A spirally-wound electrode assembly includes: a first electrode and a second electrode; a separator interposed between the first electrode and the second electrode; and a connection portion fixing first ends of portions of the separator, and the first electrode is adjacent to the connection portion and is between the portions of the separator. A rechargeable battery including a spirally-wound electrode assembly, and a method of manufacturing an electrode assembly are also provided.

### CROSS-REFERENCE TO RELATED APPLICATION

This application claims priority to and the benefit of Korean Patent Application No. 10-2012-0054359, filed on May 22, 2012 in the Korean Intellectual Property Office, the entire content of which is incorporated herein by reference.

### BACKGROUND

1. Field

Aspects of embodiments of the present invention relate to an electrode assembly, a fabricating method thereof, and a rechargeable battery.

2. Description of the Related Art

A rechargeable battery can be repeatedly charged and discharged, unlike a primary battery that is incapable of being recharged. A low-capacity rechargeable battery is commonly used for a small portable electronic device, such as a mobile phone, a laptop computer, or a camcorder. A large-capacity rechargeable battery is widely used as a power supply for driving a motor of an electric vehicle, a hybrid vehicle, and the like.

Recently, a high-power rechargeable battery using a non-aqueous electrolyte having high energy density has been developed, and the high-power rechargeable battery is configured as a large-capacity battery module by connecting a plurality of rechargeable batteries in series so as to be used for devices requiring a large amount of power, such as a motor drive of an electric vehicle, a hybrid vehicle, and the like.

Further, one battery module is configured by a plurality of rechargeable batteries which are generally connected to each other in series, and the rechargeable battery may be formed in a cylindrical shape, a square shape, or the like.

The rechargeable battery typically includes an electrode assembly including a positive electrode, a negative electrode, and a separator. The electrode assembly may be spirally wound by interposing the separator between the positive electrode and the negative electrode, or formed by alternately layering the positive electrode and the negative electrode, and interposing the separator therebetween.

In the spirally-wound electrode assembly, the separator may be first wound around the front end thereof, and then the positive and negative electrodes are wound together with the separator. However, such a typical method causes nonuniformity in interfaces in the electrode assembly because a center front end of the electrode assembly is folded. When interface nonuniformity occurs, the life span is reduced and output power may be deteriorated due to abnormal reaction during charging and discharging.

The above information disclosed in this Background section is only for enhancement of understanding of the background of the described technology and therefore it may contain information that does not form the prior art that is already known in this country to a person of ordinary skill in the art.

### SUMMARY

According to an aspect of embodiments of the present invention, an electrode assembly is configured having interface uniformity. According to other aspects of embodiments of the present invention, a method of manufacturing the electrode assembly, and a rechargeable battery including the electrode assembly are provided.

According to an exemplary embodiment of the present invention, a spirally-wound electrode assembly includes: a first electrode and a second electrode; a separator interposed between the first electrode and the second electrode; and a connection portion fixing first ends of portions of the separator, and the first electrode is adjacent to the connection portion and is between the portions of the separator.

The connection portion may be integrally formed with the separator. The connection portion may be formed by adherence or fusion of the portions of the separator.

The connection portion may include an adhesive material that fixes the first ends of the portions of the separator. The connection portion may surround a first end of the first electrode. The connection portion may be fixed by the portions of the separator contacting each other.

According to another exemplary embodiment of the present invention, a rechargeable battery includes: a spirally-wound electrode assembly including a separator interposed between a first electrode and a second electrode; a case containing the electrode assembly; and a cap assembly covering an opening of the case, and the electrode assembly includes a connection portion fixing first ends of portions of a separator that are adjacent to opposite sides of the first electrode.

The first electrode may be adjacent to the connection portion and may be inserted between the portions of the separator. The connection portion may be integrally formed with the separator.

The connection portion may be formed by fusion of the portions of the separator. The connection portion may include an adhesive material that fixes the first ends of the portions of the separator.

The connection portion may surround a first end of the first electrode. The connection portion may be fixed by the portions of the separator contacting each other.

According to another exemplary embodiment of the present invention, a method of manufacturing an electrode assembly includes: arranging a first electrode to be contact with a first side of a first winding core; surrounding the first winding core with a separator; joining first ends of portions of the separator with each other; arranging the first electrode and the separator between the first winding core and a second winding core; and spirally winding the first electrode, a second electrode, and the separator by rotating the first and second winding cores.

The surrounding the first winding core may include surrounding the first winding core with the separator together with the first electrode. The arranging the first electrode and the separator between the first winding core and the second winding core may include arranging a front end of the second electrode adjacent to an end of the second winding core.

According to an aspect of embodiments of the present invention, an electrode is disposed adjacent to a front end of the separator to which the electrode is fixed such that interface uniformity of the electrode assembly is improved.

### BRIEF DESCRIPTION OF THE DRAWINGS

The accompanying drawings, together with the specification, illustrate some exemplary embodiments of the present invention, and, together with the description, serve to explain aspects and principles of the present invention.

FIG. 1 is a perspective view of a rechargeable battery according to an exemplary embodiment of the present invention.

FIG. 2 is a cross-sectional view of the rechargeable battery of FIG. 1, taken along the line II-II.

FIG. 3 is a perspective view of an electrode assembly according to an exemplary embodiment of the present invention.

FIG. 4 is a cross-sectional view of the electrode assembly of FIG. 3, taken along the line IV-IV.

FIG. 5A to FIG. 5C illustrate tasks of a method of manufacturing an electrode assembly according to an exemplary embodiment of the present invention.

FIG. 6A is a computer tomography (CT) image of a cross-section of a conventional electrode assembly, and FIG. 6B is a CT image of a cross-section of the electrode assembly according to an exemplary embodiment of the present invention.

FIG. 7 is a cross-sectional view of an electrode assembly according to another exemplary embodiment of the present invention.

FIG. 8 is a cross-sectional view of an electrode assembly according to another exemplary embodiment of the present invention.

Description of Reference Numerals Indicating Some Elements
in the Drawings

| | |
|---|---|
| 101: rechargeable battery | 10, 70, 80: electrode assembly |
| 11, 71, 81: first electrode | 12, 72, 82: second electrode |
| 13, 73, 83: separator | 13a, 73a, 83a: connection portion |
| 20: cap assembly | 21: first terminal |
| 22: second terminal | 23: seal stopper |
| 24: first gasket | 25: cap plate |
| 26: second gasket | 27: vent member |
| 29: nut | 30: case |
| 51, 52: current collecting member | 60: roller |
| 61: first winding core | 62: second winding core |

### DETAILED DESCRIPTION

The present invention is described more fully hereinafter with reference to the accompanying drawings, in which some exemplary embodiments of the invention are shown and described. However, as those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

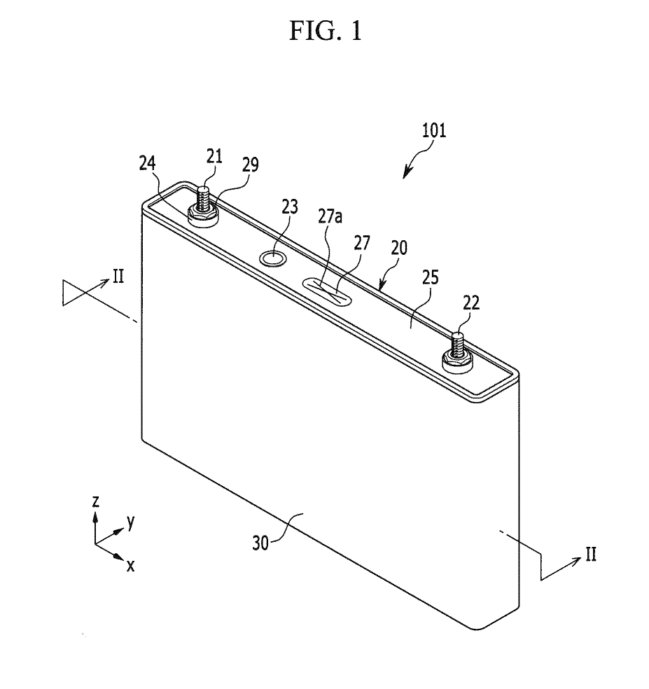

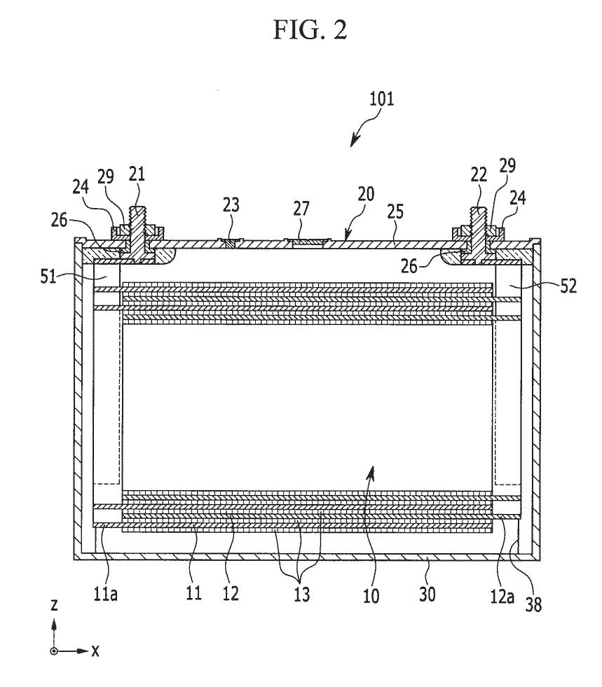

FIG. 1 is a perspective view of a rechargeable battery according to an exemplary embodiment of the present invention, and FIG. 2 is a cross-sectional view of the rechargeable battery of FIG. 1, taken along the line II-II.

Referring to FIG. 1 and FIG. 2, a rechargeable battery 101 according to an exemplary embodiment of the present invention includes an electrode assembly 10 spirally wound including a first electrode 11 (e.g., a positive electrode) and a second electrode 12 (e.g., a negative electrode) with a separator 13 interposed between the first and second electrodes 11 and 12, a case 30 in which the electrode assembly 10 is contained, and a cap assembly 20 coupled to an opening of the case 30.

The rechargeable battery 101 according to an exemplary embodiment of the present invention is illustrated as a lithium ion rechargeable battery having a generally prismatic shape. However, the present invention is not limited thereto, and the present invention may be applied to a lithium polymer battery, a cylindrical battery, or the like.

In an exemplary embodiment of the present invention, the rechargeable battery is formed as a lithium polymer battery. However, the present invention is not limited thereto, and the rechargeable battery, in another embodiment, may be formed as a lithium ion battery, for example.

The first electrode 11 and the second electrode 12 are spirally wound having the separator 13, as an insulator, interposed therebetween.

The case 30, in one embodiment, is formed having a generally cuboid or prismatic shape and having an opening at an end thereof. The cap assembly 20, in one embodiment, includes a cap plate 25 that covers an opening of the case 30, a first terminal 21 that is protruded to the outside of the cap plate 25 and that is electrically connected to the first electrode 11, a second terminal 22 that is protruded to the outside of the cap plate 25 and that is electrically connected to the second electrode 12, and a vent member 27 that has a notch 27a to be torn or ruptured according to a an internal pressure (e.g., a predetermined internal pressure).

The cap plate 25, in one embodiment, is formed as a thin metal plate, and is fixed to the opening of the case 30, such as by welding. In one embodiment, an electrolyte injection opening for injecting an electrolyte solution is formed at one side of the cap plate 25, and a seal stopper 23 for sealing the electrolyte injection opening is fixed to the cap plate 25.

In one embodiment, the first terminal 21 penetrates the cap plate 25, a first gasket 24 is provided at an upper portion between the cap plate 25 and the first terminal 21, and a second gasket 26 is provided at a lower portion between the cap plate 25 and the first terminal 21 to insulate the cap plate 25 and the first terminal 21.

The first terminal 21, in one embodiment, is formed in a circular cylindrical shape, a nut 29 that supports the first terminal 21 at an upper part is installed on the first terminal 21, and a screw thread for fastening the nut 29 is formed on an external circumference of the first terminal 21.

The first terminal 21 is electrically connected to an uncoated region 11a of the first electrode 11 through a current collecting member 51 as an intermediary, and a terminal flange that supports the first terminal 21 and the current collecting member 51 is formed at a lower end of the first terminal 21.

In one embodiment, the second terminal 22 penetrates the cap plate 25, a first gasket 24 is provided at an upper portion between the cap plate 25 and the second terminal 22, and a second gasket 26 is provided at a lower portion between the cap plate 25 and the second terminal 22 to insulate the cap plate 25 and the second terminal 22.

The second terminal 22, in one embodiment, is formed in a circular cylindrical shape, a nut 29 supporting the second terminal 22 at an upper portion is provided on the second terminal 22, and a screw thread for fastening the nut 29 is formed on an external circumference of the second terminal 22.

The second terminal 22 is electrically connected to an uncoated region 12a of the second electrode 12 through a current collecting member 52 as an intermediary, and a terminal flange that supports the second terminal 22 and the current collecting member 52 is formed at a lower end of the second terminal 22.

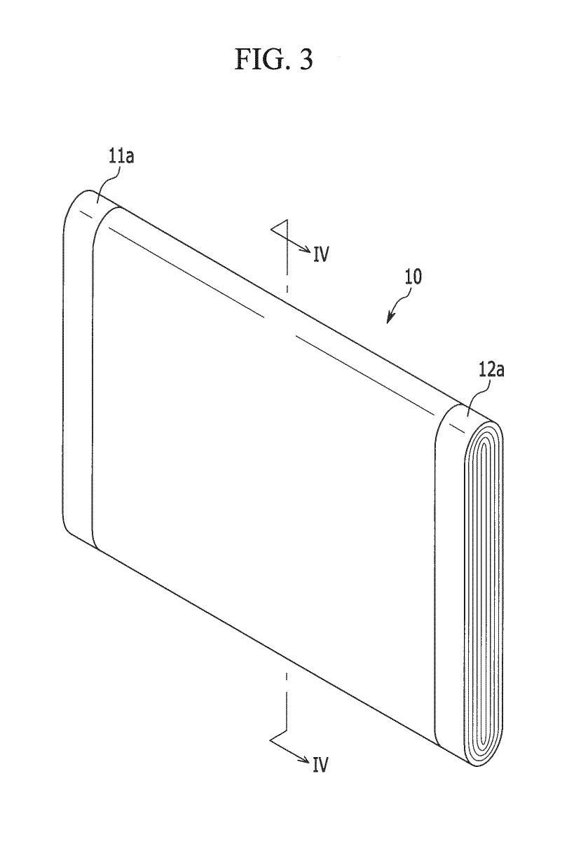

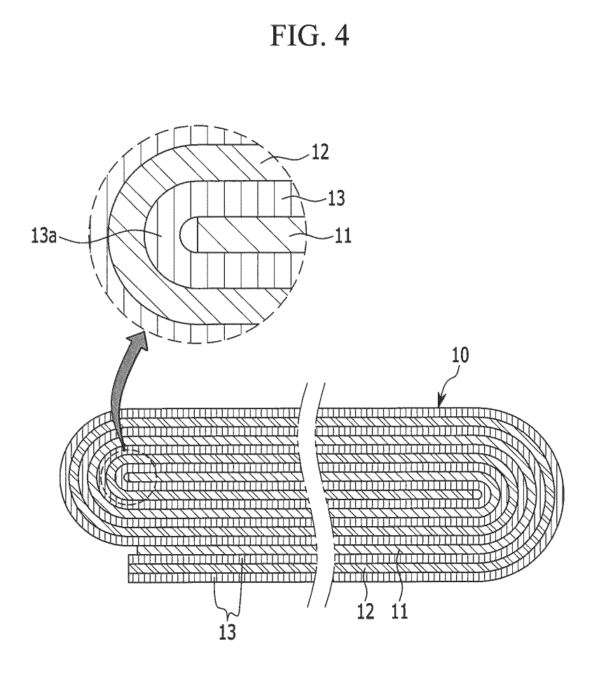

FIG. 3 is a perspective view of an electrode assembly according to an exemplary embodiment of the present invention, and FIG. 4 is a cross-sectional view of the electrode assembly of FIG. 3, taken along the line IV-IV.

Referring to FIG. 3 and FIG. 4, the electrode assembly 10 according to an exemplary embodiment of the present invention includes the first electrode 11, the second electrode 12, and two sheets of separators 13 interposed between the first electrode 11 and the second electrode 12. The first electrode 11, the second electrode 12, and the separator 13 are formed in the shape of a band extended in a direction.

In one embodiment, the first electrode 11 is a positive electrode and the second electrode 12 is a negative electrode. However, the present invention is not limited thereto, and, in another embodiment, the first electrode 11 may be a negative electrode and the second electrode 12 may be a positive electrode.

The first electrode 11 includes a current collector and an active material layer. A coated region coated with an active material, and an uncoated region that is not coated with the active material are formed in the first electrode 11. The first electrode uncoated region 11a is formed at one end of the first electrode 11 along a lengthwise direction of the first electrode 11.

The second electrode 12 includes a current collector and an active material layer. A coated region that is coated with an active material and an uncoated region that is not coated with the active material are formed in the second electrode 12. The second electrode uncoated region 12a is formed at one end of the second electrode 12 along a lengthwise direction of the second electrode 12.

The separator 13 is formed as a porous film, and may be formed of polyolephine, polyethylene, polyimide, polyamide-imide, and the like.

Both sides of the first electrode 11 respectively contact the separators 13, and accordingly, a connection portion 13a is fixed to a front end where the two sheets of separators 13 meet each other. The connection portion 13a, in one embodiment, is formed by extending the separator 13. The connection portion 13a may be formed of the same material as the separator 13, and the connection portion 13a may be integrally formed with the separator 13. In one embodiment, a portion of front ends of neighboring separators 13 may be fused and fixed such that the connection portion 13a is formed.

In one embodiment, the first electrode 11 is disposed to be adjacent to the connection portion 13a and is inserted between the separators 13, and both sides of the first electrode 11 contact the respective adjacent separators 13. A front end of the second electrode 12 is disposed to be adjacent to a bent portion of the first electrode 11.

As described above, according to an exemplary embodiment of the present invention, the connection portion 13a is formed in the separator 13 and thus the separator 13 surrounds the front end of the first electrode 11, and the front end of the first electrode 11 is disposed in a width directional end from the center of the electrode assembly 10 such that an interface of the electrode assembly 10 is uniform or substantially uniform. In addition, the front end of the second electrode 12 is disposed in the bent portion of the first electrode 11, and, accordingly, the interface of the electrode assembly 10 is uniform or substantially uniform.

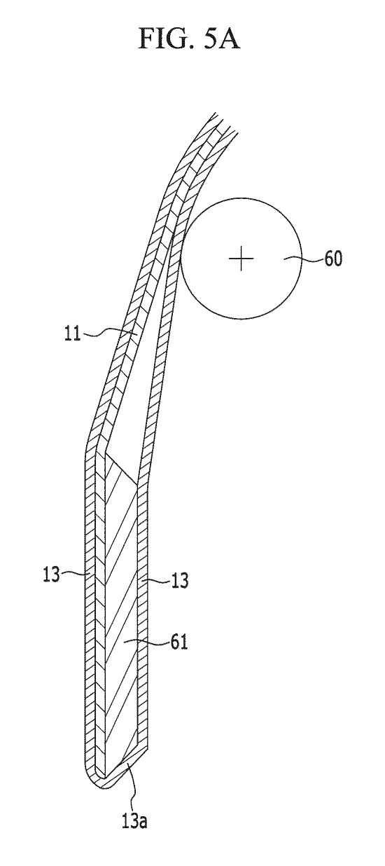

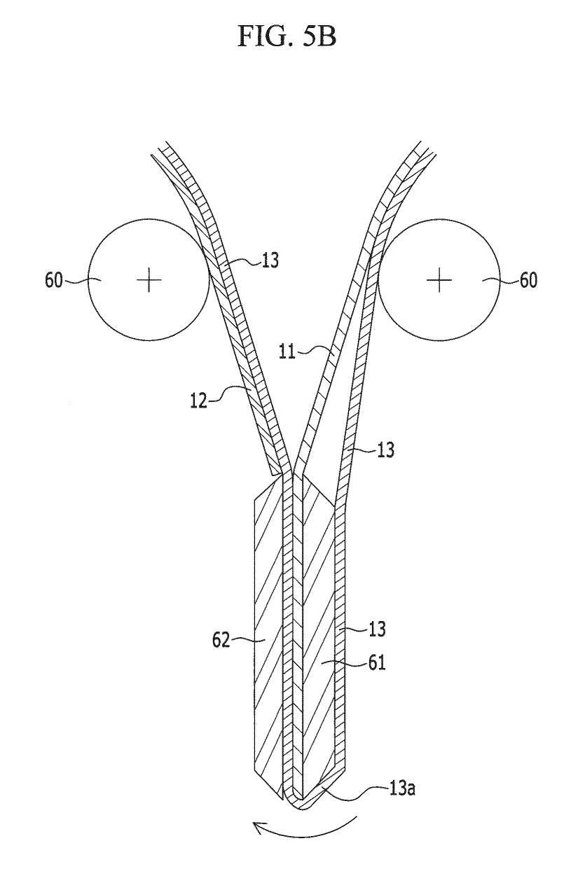

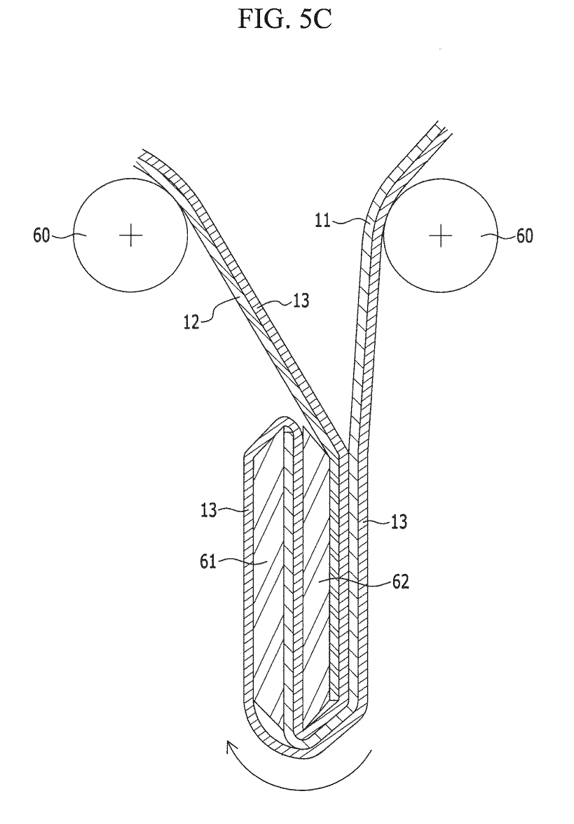

FIG. 5A to FIG. 5C illustrate tasks of a method of manufacturing an electrode assembly according to an exemplary embodiment of the present invention.

Referring to FIG. 5A to FIG. 5C, a method of manufacturing the electrode assembly 10 includes a task of disposing the first electrode 11 to be in contact with an inner side of a first winding core 61, a task of disposing the separators 13 having front ends thereof contacting each other to surround the first winding core 61, a task of disposing a second winding core 62 for disposing the first electrode 11 and the separator 13 between the first winding core 61 and the second winding core 62, and a task of spirally winding the first electrode 11, the second electrode 12, and the separator 13 by rotating the first and second winding cores 61 and 62.

As shown in FIG. 5A, in the task of disposing the first electrode 11, the first electrode 11 is tightly attached to a side of the first winding core 61 that faces the second winding core 62.

In one embodiment, the first winding core 61 and the second winding core 62 have the shape of a plate having an inclined surface. However, the present invention is not limited thereto, and, in another embodiment, external surfaces of the first winding core 61 and the second winding core 62 may be formed in the shape of a convex arc, for example.

In the task of disposing the separator 13, the separator 13 surrounds the first electrode 11 and the first winding core 61. The front ends of the separators 13 are fixed to each other by fusion or the like.

In one embodiment, one side separator 13 surrounds the external surface of the first winding core 61 and the other side separator 13 surrounds the first electrode 11. Accordingly, the front end of the first electrode 11 and the first winding core 61 are disposed between the separators 13.

As shown in FIG. 5B, in the task of disposing the second winding core 62, the first electrode 11 and the separator 13 are disposed between the inner surface of the first winding core 61 and the inner surface of the second winding core 62 by disposing the first winding core 61 and the second winding core 62 to be adjacent to each other.

In addition, the task of disposing the second winding core 62 includes disposing the second electrode 12 to locate the front end of the second electrode 12 to be adjacent to one end of the second winding core 62. When the front end of the second electrode 12 is disposed adjacent to one end of the second winding core 62, the front end of the second electrode 12 is located at the bent portion of the first electrode 11.

In the spirally winding task, the first winding core 61 and the second winding core 62 are rotated together such that the separator 13 is spirally wound by rotating the separator 13 interposed between the first winding core 61 and the second winding core 62.

In one embodiment, one side separator 13 and the first electrode 11 move with guidance of a roller 60 rotatably provided at an upper portion of the first winding core 61. In addition, the other side separator 13 and the second electrode 12 move with guidance of a roller 60 rotatably provided at an upper portion of the second winding core 62.

As described above, according to an exemplary embodiment of the present invention, the first electrode 11 is disposed and the separator 13 is spirally wound while surrounding the first electrode 11, and thus the front end of the first electrode 11 can be located in the width directional end in the inner side of the electrode assembly 10. Accordingly, a thickness of the electrode assembly 10 is uniform or substantially uniform, thereby improving interface uniformity of the electrode assembly 10.

In addition, according to an exemplary embodiment of the present invention, the separately formed first and second winding cores 61 and 62 may be tightly attached to the first electrode 11, and therefore the first and second winding cores 61 and 62 can be spirally wound easily by applying a sufficient tension force to the first electrode 11 without folding the front end of the first electrode 11.

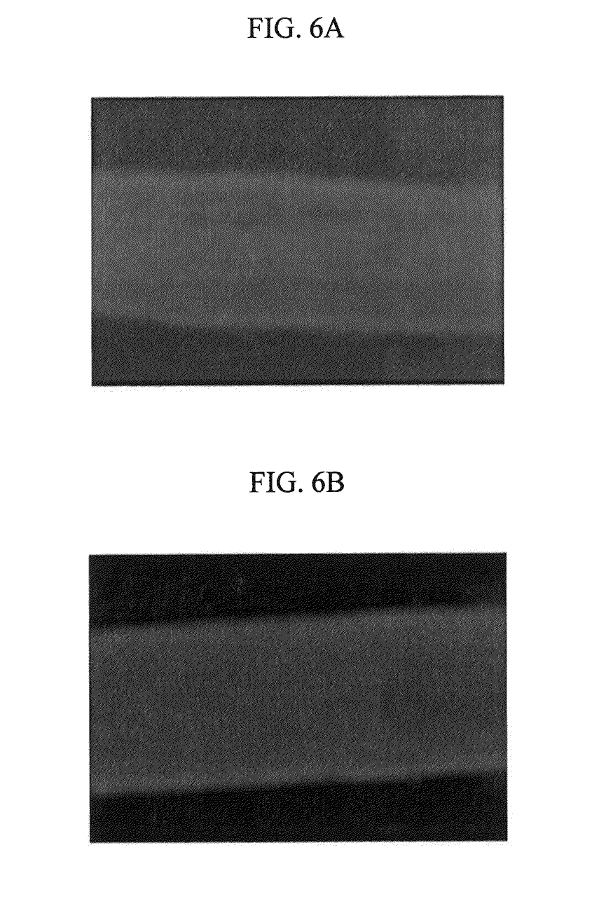

FIG. 6A is a computer tomography (CT) image of a cross-section of a conventional electrode assembly, and FIG. 6B is a CT image of a cross-section of the electrode assembly according to an exemplary embodiment of the present invention.

As shown in FIG. 6A, the conventional electrode assembly has internal deformation such that a gap is formed between interfaces, and, as shown in FIG. 6B, the electrode assembly according to an exemplary embodiment of the present invention has uniform interfaces.

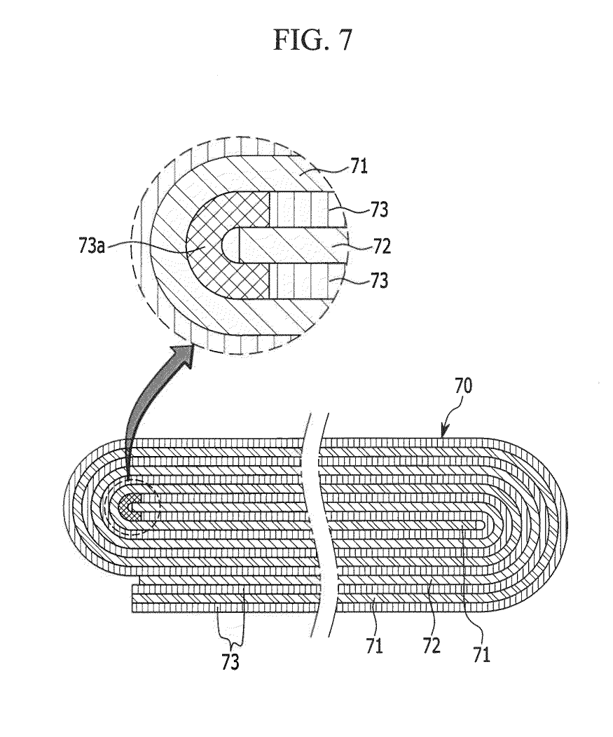

FIG. 7 is a cross-sectional view of an electrode assembly according to another exemplary embodiment of the present invention.

A rechargeable battery according to another exemplary embodiment of the present invention is the same as the rechargeable battery 101 described above, excluding a structure of an electrode assembly 70, and therefore a repeated description of the same structure will be omitted.

The electrode assembly 70 according to another exemplary embodiment of the present invention includes a first electrode 71, a second electrode 72, and two sheets of separators 73 interposed between the first electrode 71 and the second electrode 72. The first electrode 71, the second electrode 72, and the separator 73 are formed in the shape of a band extended in a direction.

The first electrode 71 includes a first electrode current collector and an active material layer. The first electrode 71 includes a coated region that is coated with an active material and an uncoated region that is not coated with the active material. The second electrode 72 includes a second electrode current collector and an active material layer. The second electrode 72 includes a coated region that is coated with an active material and an uncoated region that is not coated with the active material. In one embodiment, the first electrode 71 may be a positive electrode and the second electrode 72 may be a negative electrode. However, the present invention is not limited thereto, and, in another embodiment, the first electrode 71 may be a negative electrode and the second electrode 72 may be a positive electrode.

The separator 73 is formed as a porous film, and may be formed of polyolephine, polyethylene, polyimide, polyamide-imide, and the like.

In one embodiment, both sides of the second electrode 72 respectively contact the separators 73, and, accordingly, a connection portion 73a is fixed to a front end where the two sheets of separators 73 meet each other.

The connection portion 73a, in one embodiment, is formed of an adhesive material to fix the front end of the separator 73. In addition, the connection portion 73a is bent to surround a front end of the second electrode 72. In an exemplary embodiment, the connection portion 73a is formed to surround the front end of the second electrode 72, and the connection portion 73a stably fixes the second electrode 72 such that the interface is uniform or substantially uniform.

The second electrode 72 is inserted between the separator 73, and a front end of the first electrode 71 is disposed adjacent to a bent portion of the second electrode 72. Accordingly, a thickness of the electrode assembly 70 at the inner center thereof is uniform or substantially uniform, thereby improving uniformity of the interface of the electrode assembly 70.

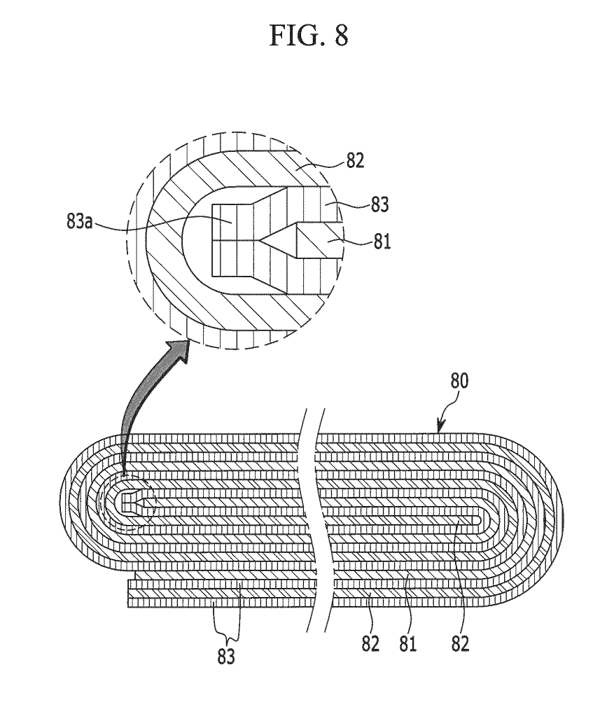

FIG. 8 is a cross-sectional view of an electrode assembly according to another exemplary embodiment of the present invention.

A rechargeable battery according to another exemplary embodiment of the present invention is the same as the rechargeable battery 101 described above, excluding a structure of an electrode assembly 80, and therefore a repeated description of the same structure will be omitted.

The electrode assembly 80 according to another exemplary embodiment of the present invention includes a first electrode 81, a second electrode 82, and two sheets of separators 83 interposed between the first electrode 81 and the second electrode 82. The first electrode 81, the second electrode 82, and the separator 83 are formed in the shape of a band extended in a direction.

The first electrode 81 includes a first electrode current collector and an active material layer. The first electrode 81 includes a coated region that is coated with an active material and an uncoated region that is not coated with the active material. The second electrode 82 includes a second electrode current collector and an active material layer. The second electrode 82 includes a coated region that is coated with an active material and an uncoated region that is not coated with the active material. In one embodiment, the first electrode 81 may be a positive electrode and the second electrode 82 may be a negative electrode. However, the present invention is not limited thereto, and, in another embodiment, the first electrode 81 may be a negative electrode and the second electrode 82 may be a positive electrode.

The separator 83 is formed as a porous film, and may be formed of polyolephine, polyethylene, polyimide, polyamide-imide, and the like.

In one embodiment, both sides of the first electrode 81 respectively contact the separators 83, and a connection portion 83a is fixed to a front end where the two sheets of separators 83 meet each other.

The connection portion 83a contacts the neighboring separators 83 and is layered with the separators 83. In one embodiment, the separators 83 are adhered using an adhesive, and may be fused and fixed to form the connection portion 83a.

In one embodiment, the first electrode 81 is disposed adjacent to the connection portion 83a and inserted between the separators 83, and a front end of the second electrode 82 is disposed adjacent to a bent portion of the first electrode 81. Accordingly, a thickness of the electrode assembly 80 at the inner center thereof is uniform or substantially uniform, thereby improving uniformity of the interface of the electrode assembly 80.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A spirally-wound electrode assembly comprising:
a first electrode and a second electrode;
a separator interposed between the first electrode and the second electrode; and
a connection portion fixing first ends of portions of the separator,
wherein the first electrode is adjacent to the connection portion and is between the portions of the separator.

2. The electrode assembly of claim 1, wherein the connection portion is integrally formed with the separator.

3. The electrode assembly of claim 1, wherein the connection portion is formed by fusion of the portions of the separator.

4. The electrode assembly of claim 1, wherein the connection portion comprises an adhesive material that fixes the first ends of the portions of the separator.

5. The electrode assembly of claim 1, wherein the connection portion surrounds a first end of the first electrode.

6. The electrode assembly of claim 1, wherein the connection portion is fixed by the portions of the separator contacting each other.

7. A rechargeable battery comprising:
a spirally-wound electrode assembly including a separator interposed between a first electrode and a second electrode;
a case containing the electrode assembly; and
a cap assembly covering an opening of the case,
wherein the electrode assembly comprises a connection portion fixing first ends of portions of a separator that are adjacent to opposite sides of the first electrode.

8. The rechargeable battery of claim 7, wherein the first electrode is adjacent to the connection portion and is between the portions of the separator.

9. The rechargeable battery of claim 7, wherein the connection portion is integrally formed with the separator.

10. The rechargeable battery of claim 7, wherein the connection portion is formed by fusion of the portions of the separator.

11. The rechargeable battery of claim 7, wherein the connection portion comprises an adhesive material that fixes the first ends of the portions of the separator.

12. The rechargeable battery of claim 7, wherein the connection portion surrounds a first end of the first electrode.

13. The rechargeable battery of claim 7, wherein the connection portion is fixed by the portions of the separator contacting each other.

14. A method of manufacturing an electrode assembly, the method comprising:
arranging a first electrode to be contact with a first side of a first winding core;
surrounding the first winding core with a separator;
joining first ends of portions of the separator with each other;
arranging the first electrode and the separator between the first winding core and a second winding core; and
spirally winding the first electrode, a second electrode, and the separator by rotating the first and second winding cores.

15. The manufacturing method of the electrode assembly of claim 14, wherein the surrounding the first winding core comprises surrounding the first winding core with the separator together with the first electrode.

16. The manufacturing method of the electrode assembly of claim 14, wherein the arranging the first electrode and the separator between the first winding core and the second winding core comprises arranging a front end of the second electrode adjacent to an end of the second winding core.
